(19) United States
(12) Patent Application Publication
(10) Pub. No.: US 2023/0153568 A1
(43) Pub. Date: May 18, 2023

(54) GRAPH NEURAL NETWORK ACCELERATOR WITH NEGATIVE SAMPLING

(71) Applicant: T-Head (Shanghai) Semiconductor Co., Ltd., Shanghai Free Trade Area (CN)

(72) Inventors: Tianchan GUAN, Shanghai (CN); Shuangchen LI, Sunnyvale, CA (US); Heng LIU, Shanghai (CN); Hongzhong ZHENG, Los Gatos, CA (US)

(21) Appl. No.: 17/574,528

(22) Filed: Jan. 12, 2022

(30) Foreign Application Priority Data
Nov. 15, 2021 (CN) 202111345963.1

(51) Int. Cl. G06N 3/04; G06N 3/08

(52) U.S. Cl. CPC G06N 3/04; G06N 3/08

(57) ABSTRACT

This application describes an accelerator, a computer system, and a method for accelerating Graph Neural Network (GNN) node attribute fetching. The accelerator comprises a graph structure processor configured to obtain, according to a root node in a graph, a plurality of candidate nodes for GNN processing on the root node; a GNN sampler configured to generate sampled graph nodes based on the plurality of candidate nodes from the graph structure processor; and a GNN attribute processor configured to fetch attribute data of the sampled graph nodes received from the GNN sampler for the GNN processing on the root node.

### CROSS REFERENCE To RELATED APPLICATION

This application claims priority to and benefits of Chinese patent Application No. 202111345963.1, filed with the China National Intellectual Property Administration (CNIPA) on Nov. 15, 2021. The entire contents of the above-identified application are incorporated herein by reference.

### TECHNICAL FIELD

The disclosure relates generally to accelerating graph neural networks (GNNs) computations. More specifically, this disclosure relates to a hardware accelerator, a computer system, and a method for accelerating GNN operations by providing a built-in negative sampling function.

### BACKGROUND

One of the challenges that have so far precluded the wide adoption of GNNs in industrial applications is the difficulty to scale them to large graphs. For instance, a social media of reasonable size may be represented by a graph that has hundreds of millions of nodes and billions of edges, where each node or edge may have attribute data that need to be stored and accessed during the GNN computations. However, training the GNN by computing the feature representations of all nodes in the graph may be too costly and sometimes impractical. To address this scalability issue, sampling methods have been studied to reduce the amount of data to be computed in GNNs.

### SUMMARY

Various embodiments of the present specification may include hardware accelerators, systems, methods for accelerating GNN sampling efficiency.

According to one aspect, an accelerator for accelerating Graph Neural Network (GNN) sampling efficiency is described. The accelerator may include a graph structure processor configured to obtain, according to a root node in a graph for GNN processing on the root node; a GNN sampler configured to generate sampled graph nodes based on the plurality of candidate nodes from the graph structure processor; and a GNN attribute processor configured to fetch attribute data of the sampled graph nodes received from the GNN sampler for the GNN processing on the root node.

In some embodiments, the plurality of candidate nodes are within k-th order neighborhood of the root node, wherein k is a preset distance from the root node.

In some embodiments, the GNN sampler comprises: a positive sampler configured to sample one or more first positive nodes from the plurality of candidate nodes and send the one or more first positive nodes to the GNN attribute processor for fetching corresponding attribute data; and a negative sampler configured to sample one or more provisional negative nodes from a plurality of nodes in the graph other than the plurality of candidate nodes and send the one or more provisional negative nodes back to the graph structure processor for another round of positive sampling based on the one or more negative nodes.

In some embodiments, the GNN attribute processor is further configured to: fetch attribute data of the one or more first positive nodes for training a neural network to generate a feature representation of the root node, wherein the training comprises minimizing a feature distance from the feature representation of the root node to feature representations of the one or more first positive nodes, wherein the feature representations of the one or more first positive nodes are determined based on the attribute data of the one or more first positive nodes.

In some embodiments, the graph structure processor is further configured to: for each of the one or more provisional negative nodes, obtain a plurality of candidate nodes of the negative node that are within the first to k-th order neighborhood of the provisional negative node, wherein k is a preset distance from the provisional negative node.

In some embodiments, the GNN sampler is further configured to: sample one or more second positive nodes from the plurality of candidate nodes of the provisional negative node.

In some embodiments, the GNN attribute processor is further configured to: fetch attribute data of the one or more second positive nodes for training a neural network to generate a feature representation of the root node, wherein the training comprises maximizing a feature distance from the feature representation to feature representations of the one or more second positive nodes, wherein the feature representations of the one or more second positive nodes are determined based on the attribute data of the one or more second positive nodes.

According to another aspect, a computer-implemented method for accelerating Graph Neural Network (GNN) sampling efficiency is described. The method includes obtaining, by a GNN accelerator, a root node of a graph for GNN processing; determining, by the GNN accelerator, a plurality of candidate nodes from the graph based on the root node; determining, by the GNN accelerator based on the plurality of candidate nodes, one or more first positive nodes and one or more negative nodes, wherein the one or more first positive nodes are within a preset distance from the root node, and the one or more negative nodes are outside of the preset distance from the root node; and obtaining, by the GNN accelerator, attribute data based on the one or more first positive nodes and the one or more negative nodes for GNN processing on the root node of the graph.

In some embodiments, the plurality of candidate nodes are within k-th order neighborhood of the root node, wherein k is a preset distance from the root node.

In some embodiments, the determining the one or more first positive nodes based on the plurality of candidate nodes comprises: sampling a subset of the plurality of candidate nodes of the root node; and the determining the one or more negative nodes based on the plurality of candidate nodes comprises: determining one or more provisional negative nodes in the graph other than the plurality of candidate nodes of the root node; and sampling the one or more negative nodes from the one or more provisional negative nodes.

In some embodiments, the method may further comprise determining one or more provisional negative nodes in the graph other than the plurality of candidate nodes of the root node, and storing the one or more provisional negative nodes in a negative sample node buffer of the GNN accelerator for another round of positive sampling.

In some embodiments, the method may further comprise, for each of the one or more provisional negative nodes, determining, by the GNN accelerator, one or more second positive nodes that are within the distance from the provisional negative node.

In some embodiments, the obtaining attribute data based on the one or more first positive nodes and the one or more negative nodes for GNN processing on the root node of the graph comprises: obtaining the attribute data of the one or more first positive nodes and the one or more second positive nodes for the GNN processing on the root node of the graph.

In some embodiments, the GNN processing on the root node comprises training a neural network to generate a feature representation of the root node, wherein the training comprises minimizing a feature distance from the feature representation of the root node to feature representations of the one or more first positive nodes, wherein the feature representations of the one or more first positive nodes are determined based on the attribute data of the one or more first positive nodes.

In some embodiments, the GNN processing on the root node further comprises: training a neural network to generate a feature representation of the root node, wherein the training comprises maximizing a feature distance from the feature representation to feature representations of the one or more second positive nodes, wherein the feature representations of the one or more second positive nodes are determined based on the attribute data of the one or more second positive nodes.

In some embodiments, the obtaining the root node of the graph comprises: receiving the root node from a central processing unit (CPU) separated from the GNN accelerator.

In some embodiments, the obtaining the root node of the graph comprises: receiving a batch size from a processor separated from the GNN accelerator; and obtaining from the graph the batch size of root nodes comprising the root node.

According to yet another aspect, a Graph Neural Network (GNN) accelerating device is described. The GNN accelerating device may include a first obtaining module configured to obtain a root node of a graph for GNN processing, a first determining module configured to determine a plurality of candidate nodes from the graph based on the root node, a second determining module configured to determine, based on the plurality of candidate nodes, one or more first positive nodes and one or more negative nodes, wherein the one or more first positive nodes are within a preset distance from the root node, and the one or more negative nodes are outside of the preset distance from the root node, and a second obtaining module configured to obtain attribute data based on the one or more first positive nodes and the one or more negative nodes for GNN processing on the root node of the graph.

Embodiments disclosed in the specification have one or more technical effects. In some embodiments, the described GNN accelerator offers “autonomous sampling” functionality to minimize a scheduler's involvement in the sampling process. The scheduler merely needs to specify a sampling mode (e.g., positive sampling only, or positive and negative sampling), send a root node identifier (hereafter referred to as root node ID) and/or a batch size to the GNN accelerator. The GNN accelerator then handles the sampling tasks automatically. This way, the scheduler's involvement in the sampling process is minimized to the initial sampling configuration, and the GNN accelerator can perform the sampling process in a non-stop manner. A higher sampling speed can result in a faster GNN processing or training process.

These and other features of the systems, methods, and hardware devices disclosed, and the methods of operation and functions of the related elements of structure and the combination of parts and economies of manufacture will become more apparent upon consideration of the following description and the appended claims referring to the drawings, which form a part of this specification, where like reference numerals designate corresponding parts in the figures. It is to be understood, however, that the drawings are for illustration and description only and are not intended as a definition of the limits of the invention.

### BRIEF DESCRIPTION OF THE DRAWINGS

FIG. 1 illustrates a schematic diagram of a hardware device for implementing GNN accelerators in accordance with some embodiments.

FIG. 2 illustrates a workflow in a hardware design for performing GNN sampling in accordance with some embodiments.

FIG. 3 illustrates an exemplary GNN accelerator architecture with built-in negative sampling in accordance with some embodiments.

FIG. 4 illustrates technical advantages of an exemplary GNN accelerator architecture with built-in negative sampling in accordance with some embodiments.

FIG. 5 illustrates an exemplary method of accelerating GNN processing with built-in negative sampling in accordance with some embodiments.

FIG. 6 illustrates a block diagram of a computer system apparatus for accelerating GNN processing with built-in negative sampling in accordance with some embodiments.

FIG. 7 illustrates a block diagram of a GNN accelerating device with built-in negative sampling in accordance with some embodiments.

### DETAILED DESCRIPTION

The specification is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present specification. Thus, the specification is not limited to the embodiments shown but is to be accorded the widest scope consistent with the principles and features disclosed herein.

Graph Neural Network (GNN) is a type of neural network that can directly operate on a graph that has gained increasing popularity in various domains, including social networks, knowledge graphs, recommender systems, and even life science applications. The graph may have different practical meanings depending on the use cases. For example, a GNN may mine the features of users on a social media network and thereby learning the relationships among the users. As another example, nano-scale molecules have an inherent graph-like structure with the ions or the atoms being the nodes and the bonds between them, edges. GNNs can be applied to learn about existing molecular structures and discover new chemical structures. At a high level, GNN involves computation on a graph structure G=(V, E) representing a graph (undirected or directed), where V denotes vertices, E denotes edges, and (V, E) may be denoted as the data set in the graph.

GNN processing may involve GNN training and GNN inference, both of which may involve GNN computations. A typical GNN computation on a node (or vertex) may involve aggregating its neighbor's (direct neighbors or each neighbor's neighbors) features and then computing new activations of the node for determining a feature representation (e.g., feature vector) of the node. Therefore, GNN processing for a small number of nodes often requires input features of a significantly larger number of nodes. Taking all neighbors for message aggregation is too costly since the nodes needed for input features would easily cover a large portion of the graph, especially for real-world graphs that are colossal in size (e.g., with hundreds of millions of nodes with billions of edges).

To make GNN more practical for these real-word applications, node sampling is often adopted to reduce the number of nodes to be involved in the message/feature aggregation. For example, positive sampling and negative sampling may be used to determine the optimization objective and the resulted variance in the GNN processing. For a given root node whose feature representation is being computed, the positive sampling may sample those graph nodes that have connections (direct or indirect) via edges with the root node (e.g., connected to and within a preset distance from the root node); the negative sampling may sample those graph nodes that are not connected via edges with the root node (e.g., outside of the preset distance from the root node). The positively sampled nodes and the negatively sampled nodes may be used to train the GNN to generate the feature representation of the root node with different training objectives.

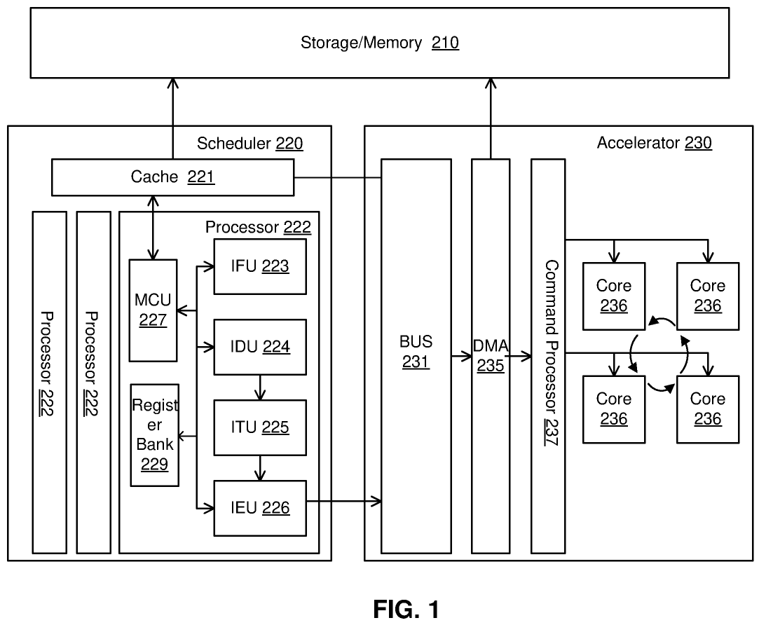

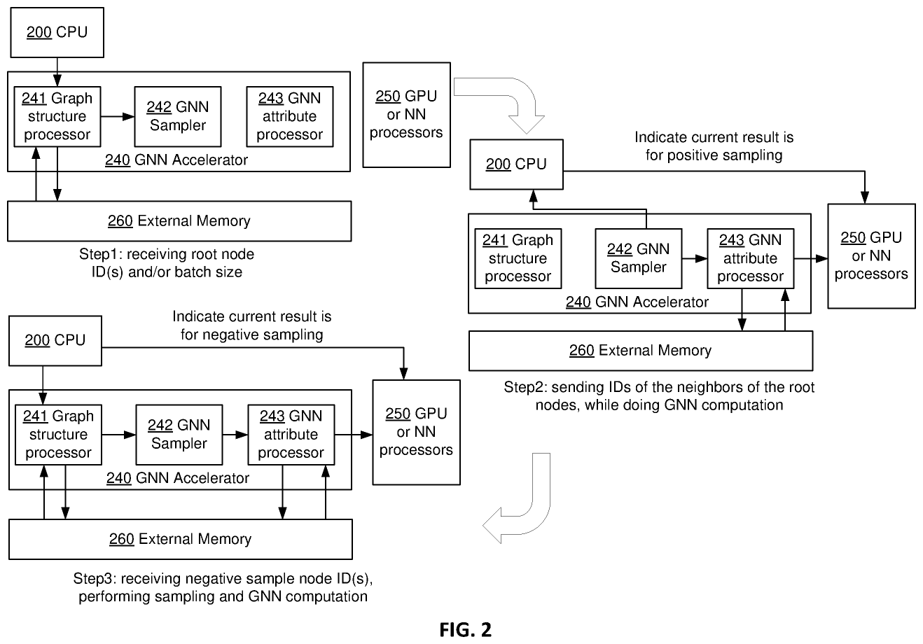

FIG. 1 illustrates a schematic diagram of a hardware device for implementing GNN accelerators in accordance with some embodiments. The hardware device in FIG. 2A illustrates the internal structures of a scheduler 220 and a GNN accelerator 230, as well as the data/instruction flow among the scheduler 220, the accelerator 230, and an external storage/memory 210.

As shown in FIG. 1, the scheduler 220 may include multiple processors 222 and a cache 221 shared by the multiple processors 222. Each processor 222 may include an instruction fetching unit (IFU) 223, an instruction decoding unit (IDU) 224, an instruction transmitting unit (ITU) 225, and an instruction execution unit (IEU) 226.

In some embodiments, the IFU 223 may fetch to-be-executed instructions or data from the storage/memory 210 to a register bank 229. In some embodiments, the to-be-executed instructions or data can be fetched into the cache 221 and send to the IFU 223 via microcontroller unit (MCU) 227. After obtaining the instructions or data, the scheduler 220 enters an instruction decoding stage. The IDU 224 decodes the obtained instruction according to a predetermined instruction format to determine operand(s) acquisition information, where the operands are required to execute the obtained instruction. In some embodiments, the operand(s) acquisition information may include pointers or addresses of immediate data, registers, or other software/hardware that provide the operand(s).

In some embodiments, the ITU 225 may be configured to receive the decoded instructions from the IDU 224 and perform instruction scheduling and management. It may efficiently allocate instructions to different IEUs 226 for parallel processing.

In some embodiments, after the ITU 225 allocates an instruction to one IEU 226, the IEU 226 may execute the instruction. However, if the IEU 226 determines that the instruction should be executed by the accelerator 230, it may forward the instruction to the corresponding accelerator 230 for execution. For example, if the instruction is directed to GNN computation based on an input graph, the IEU 226 may send the instruction to the accelerator 230 via the bus 231 for the accelerator 230 to execute the instruction.

In some embodiments, the accelerator 230 may include multiple cores 236 (4 cores are shown in FIG. 2A, but those skilled in the art may appreciate that the accelerator 230 may also include other numbers of cores 236), a command processor 237, a direct storage access (DMA) interface 235, and a bus channel 231.

The bus channel 231 may include a channel through which instructions/data enter and exit the accelerator 230. The DMA interface 235 may refer to a function provided by some computer bus architectures, which enables devices to directly read data from and/or write data to the memory 210. Compared with the method in which all data transmission between devices passes through the scheduler 220, the architecture illustrated in FIG. 2A greatly improves the efficiency of data access. For instance, the core of the accelerator 230 may directly access the memory 210 and read the parameters of a neural network model (e.g., the weight of each node) and/or input data.

The command processor 237 may be configured to allocate the instructions sent by the scheduler 220 via the IEU 226 to the cores 236 for execution. After the to-be-executed instructions enter the accelerator 230 from the bus channel 231, they may be cached in the command processor 237, and the command processor 237 may select the cores 236 and allocates the instructions to the cores 236 for execution. In addition, the command processor 237 may be also responsible for the synchronization operation among the cores 236.

In existing GNN accelerator 230 architectures, the positive and negative samplings for a root node may be controlled by the schedulers 220 or external CPUs. The schedulers 220 may send the root node and a set of instructions to a GNN accelerator 230 to perform positive sampling in one iteration, receive structural data fetched by the GNN accelerator 230 including adjacent nodes of the root node, perform the negative sampling (by the CPU, not the GNN accelerator) by selecting negative nodes from the graph other than the adjacent nodes, and send the negative nodes to the GNN accelerator 230 to perform another iteration of positive sampling to complete the sampling process. In other words, the GNN accelerator 230 is solely configured to perform positive sampling, and it is the CPU who performs the negative sampling that involves utilizing the GNN accelerator to do positive sampling on the negative nodes sampled by the CPU. However, the schedulers' 220 heavy involvement in the sampling process results in extra overhead to the overall GNN processing, e.g., the GNN accelerators may need to stop and wait for the scheduler's negative sampling to continue the sampling process. In the following description, a hardware GNN accelerator with a built-in negative sampling function is designed to autonomize the GNN sampling process and minimize the latencies caused by hardware interactions between accelerators 230 and schedulers 220.

FIG. 2 illustrates a workflow in a hardware design for performing GNN sampling in accordance with some embodiments. As shown in FIG. 2, the hardware involved in the GNN sampling include a CPU 200 (e.g., a scheduler), a GNN accelerator 240, one or more GPU or other NN processors 250 (hereafter referred to as NN processors), and an external memory 260. The GNN sampling illustrated in FIG. 2 includes positive sampling and negative sampling for GNN processing (e.g., computations involved in GNN training or inference).

In some embodiments, the GNN accelerator 240 may include a graph structure processor 241, a GNN sampler 242, and a GNN attribute processor 243. The graph structure processor 241 may be configured to communicate with the external memory 260 to obtain structural information of a graph. The structural information of the graph may allow the graph structure processor 241 to identify adjacent nodes of a given root node. The GNN sampler 242 may be configured to receive the identified nodes from the graph structure processor 241 and determine a subset of the nodes as the sampled nodes. For example, the GNN sampler 242 may follow a positive sampling distribution to sample the nodes. The GNN attribute processor 243 may be configured to receive a group of sampled nodes and communicate with the external memory 260 to obtain the attribute data of the sampled nodes. The attribute data (e.g., feature vectors) are the primary data to be computed during the GNN processing. The GNN attribute processor 243 may store the attribute data in a buffer, from which the NN processors 250 may retrieve the attribute data and perform the GNN computations accordingly.

The workflow in FIG. 2 includes three steps for performing positive and negative GNN sampling. These steps are described from the perspective of the GNN accelerator 240.

In step 1, the GNN accelerator 240 may receive instructions from the CPU 200 (or another suitable processor that is external to the GNN accelerator 240) to perform GNN sampling. In some embodiments, the instructions may include one or more root node identifiers (IDs), a batch size, another suitable information, or any combination thereof. The root node ID may correspond to a graph node whose feature representation is to be computed for training the GNN (e.g., a neural network). In other embodiments, if the instructions include only the batch size, the GNN accelerator 240 may randomly choose a batch size (indicating a quantity) of root nodes from the graph and perform the sampling. If the instructions include both root node IDs and a batch size, the batch size may be ignored. The instructions may be implemented in other forms, which are not limited in this specification. In the following description, it is assumed that the graph structure processor 241 has obtained a root node ID, regardless if the root node ID is directly received from the CPU 240 or sampled based on the batch size received from the CPU 240.

After obtaining the root node ID, the graph structure processor 241 may retrieve the structural information of the graph that is related to the root node (corresponding to the root node ID) from the external memory 260. Based on the structural information, the graph structure processor 241 may determine a plurality of candidate nodes for GNN sampling. In some embodiments, the plurality of candidate nodes include the adjacent nodes of the root node within the k-th order neighborhood of the root node, wherein k is a preset distance from the root node. In other words, the adjacent nodes of the root node refer to the k-th order neighbors of the root node that can be reached from the root node within k hops. The “preset distance” k may be configured according to the implementation. For example, if the preset distance is one, it means only the directly connected adjacent nodes are selected as the candidate nodes. The plurality of candidate nodes may then be sent to GNN sampler 242.

In step 2, the GNN sampler 242 may perform two tasks: (1) forward the plurality of candidate nodes to the CPU 200, and (2) perform positive sampling from the plurality of candidate nodes. The positive sampling may include sampling a subset of the plurality of candidate nodes as a plurality of positive nodes to be used as part of the GNN training. The GNN attribute processor 243 may obtain attribute data of these positive nodes from the external memory 260 and feed them to the NN processors 250 to perform GNN computations. The CPU 200 may also send instructions to the NN processors 250 to indicate that these nodes are positive samples, so that the NN processors 250 may perform proper computations for positive nodes. For instance, the objective of the GNN computation for positive nodes may include minimizing a feature distance between the feature vector of the root node and the attribute data (e.g., represented in feature vectors) of the positive nodes.

In step 3, the GNN accelerator 240 may receive a plurality of provisional negative nodes identified by the CPU 200 based on the received plurality of candidate nodes. For example, assuming the candidate nodes are nodes that are within k-th order neighborhood of the root node (k is a preset distance from the root node), the CPU 200 may randomly select (or following certain algorithms) nodes other than the candidate nodes as the provisional negative nodes. These provisional negative nodes may be sent to the GNN accelerator 240 to repeat the sampling process. In some embodiments, for each provisional negative nodes, the graph structure processor 241 may identify the provisional negative node's candidate nodes as candidates, the GNN sampler 242 may sample a subset of the candidates as negative nodes, and the GNN attribute processor 243 may fetch the corresponding attribute data for the NN processor 250 to process. In this case, the CPU 200 may send instructions to the NN processors 250 to indicate that these nodes are for negative sampling, so that the NN processors 250 may perform proper computations for negative nodes. For instance, the objective of the GNN computation for negative nodes may include maximizing a feature distance between the feature vector of the root node and the negative nodes.

In other words, the GNN accelerator 240 in existing hardware architectures is ignorant as to whether it is performing positive sampling or negative sampling. If the node received from the CPU 200 is a positive node (or the root node itself), the GNN accelerator 240 performs positive sampling. If the node received from the CPU 200 is a provisional negative node (e.g., not connected to the root node or outside a preset distance from the root node), the GNN accelerator 240 performs positive sampling on the provisional negative node, which is effectively performing negative sampling. Therefore, it is the CPU 200 that controls the overall sampling flow. As shown in FIG. 2, the CPU 200 is heavily involved in the sampling process. The communication cost between the CPU 200 and the GNN accelerator 240 may cause GNN sampling delays and negatively affect the GNN processing efficiency.

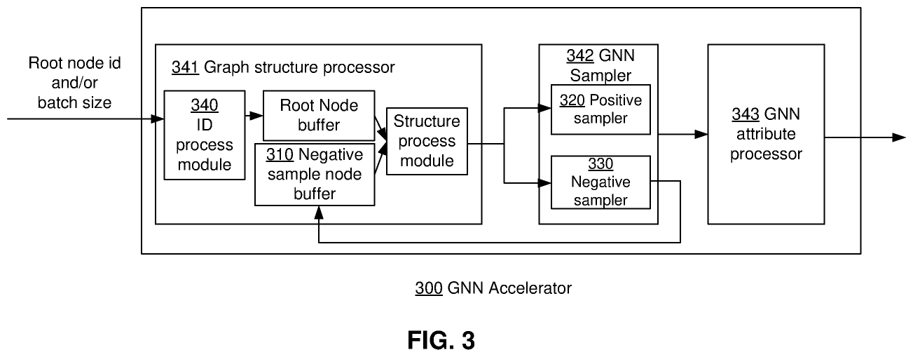

FIG. 3 illustrates an exemplary GNN accelerator architecture 300 with built-in negative sampling in accordance with some embodiments. The GNN accelerator 300 is for illustrative purposes and may include more, fewer, or alternative components.

In some embodiments, the GNN accelerator 300 may include a graph structure processor 341, a GNN sampler 342, and a GNN attribute processor 343, just like the GNN accelerator 240 in FIG. 2. However, the GNN accelerator 300 is different from the GNN accelerator 240 in several ways. First, the GNN sampler 342 in the GNN accelerator 300 may include a positive sampler 320 and a negative sampler 330. The positive sampler 320 may identify positive nodes from candidate nodes received from the graph structure processor 341 for positive training purposes, and the negative sampler 330 may select graph nodes other than the candidate nodes as the provisional negative nodes, which will be used to determine the negative nodes for negative training purposes. Second, the graph structure processor 341 in the GNN accelerator 300 may include a negative sample node buffer 310 to temporarily hold the provisional negative nodes sampled by the GNN sampler 342. This way, the graph structure processor 341 may fetch the provisional negative nodes from negative sample node buffer 310 rather than waiting to receive them from the scheduler (e.g., the CPU 200 in FIG. 2).

With these additional hardware configurations in the GNN accelerator 300, a GNN sampling process may be performed with the following steps to minimize the communication cost with external schedulers (e.g., CPUs) and improve the sampling efficiency for GNN processing.

In step 1, the graph structure processor 341 obtains root node identifiers (also called root node IDs) through an ID process module 340. These root node IDs may be directly received from the scheduler or obtained by the ID process module 340 from external memory based on instructions from the scheduler. For instance, if the scheduler sends a root node ID and a batch size, it means that the GNN accelerator 300 needs to obtain attribute data of the batch size of sampled nodes to train the GNN to generate the feature representation of the root node corresponding to the root node ID.

In step 2, the graph structure processor 341 may store the root node IDs in a root node buffer for processing. For each of the root node IDs, a structure processing module in the graph structure processor 341 may retrieve structural information of the graph based on the root node ID and determine candidate nodes based on the structural information of the graph. The candidate nodes may be referred to as adjacent nodes of the root node.

In step 3, the graph structure processor 341 may send the candidate nodes to the GNN sampler 342 for sampling. In some embodiments, both the positive sampler 320 and the negative sampler 320 may receive the candidate nodes. The positive sampler 320 may sample a subset of the candidate nodes following a positive sampling distribution, denoted as positive nodes. The negative sampler 330 may determine a plurality of nodes in the graph other than the candidate nodes, and sample a subset of the plurality of nodes following a negative sampling distribution, denoted as provisional negative nodes. For example, assuming the candidate nodes are within a k-th order neighborhood of the root node, the provisional negative nodes may include nodes that are outside of the k-th order neighborhood of the root node (e.g., not within the k-th order neighborhood of the root node but within a 2*k-th order neighborhood of the root node).

In step 4, the positive nodes sampled by the positive sampler 320 may be sent to the GNN attribute processor 343 to fetch corresponding attribute data for GNN processing. At the same time, the provisional negative nodes sampled by the negative sampler 320 may be sent to the negative sampler node buffer 310 in the graph structure processor 341 for automatic negative sampling. In some embodiments, the GNN attribute processor 343 may mark the attribute data of the positive nodes as positive sampling results. In the subsequent GNN computations, these positive sampling results (also called positive samples) may be used to train/update the feature vector of the root node so that the feature distance between the feature vector of the root node and these positive nodes is minimized.

In step 5, the graph structure processor 341 may fetch provisional negative nodes from the negative sample node buffer 310 to perform positive sampling on the provisional negative nodes, which is equivalent to performing negative sampling for the root node. For example, the graph structure processor 341 may fetch a provisional negative node and send it to the structure process module. The structure process module may obtain the structural information of the graph related to the provisional negative node and determine candidate nodes of the provisional negative node. These candidate nodes of the provisional negative node may be sent to the positive sampler 320 to perform another round of positive sampling following the positive sampling distribution to obtain one or more second positive nodes. The second positive nodes may be deemed as negative nodes for negative sampling and sent to the GNN attribute processor 343 for computation. In some embodiments, the GNN attribute processor 343 may mark the attribute data of the negative nodes as negative sampling results. In the subsequent GNN computations, these negative sampling results (also called negative samples) may be used to train/update the feature vector of the root node so that the feature distance between the feature vector of the root node and these negative nodes is maximized. In other embodiments, besides the second positive nodes, the provisional negative nodes or a subset of the provisional negative nodes may also be treated as negative samples and sent to the GNN attribute processor 343 for negative training.

The above-described step 3 and step 5 may be deemed as two iterations for GNN sampling involving both positive sampling and negative sampling. In step 3, both the positive sampler 320 and the negative sampler 330 are configured to perform corresponding sampling based on the same candidate nodes. In step 5, only the positive sampler 320 is configured to perform positive sampling based on the provisional negative nodes generated by the negative sampler in step 3.

In some embodiments, the GNN accelerator 300 may provide a knob to turn on or off the negative sampling function. For example, the scheduler (e.g., a CPU) may specify the sampling mode, such as positive sampling only, negative sampling only, positive and negative sampling, etc. If the sampling mode is selected as positive sampling only, the negative sampler 330 will be disabled in the above step 3 and step 5 will be skipped. If the sampling mode is selected as positive and negative sampling, the GNN accelerator 300 may automatically perform the above-described pipeline without the intervention from outside scheduler between samplings.

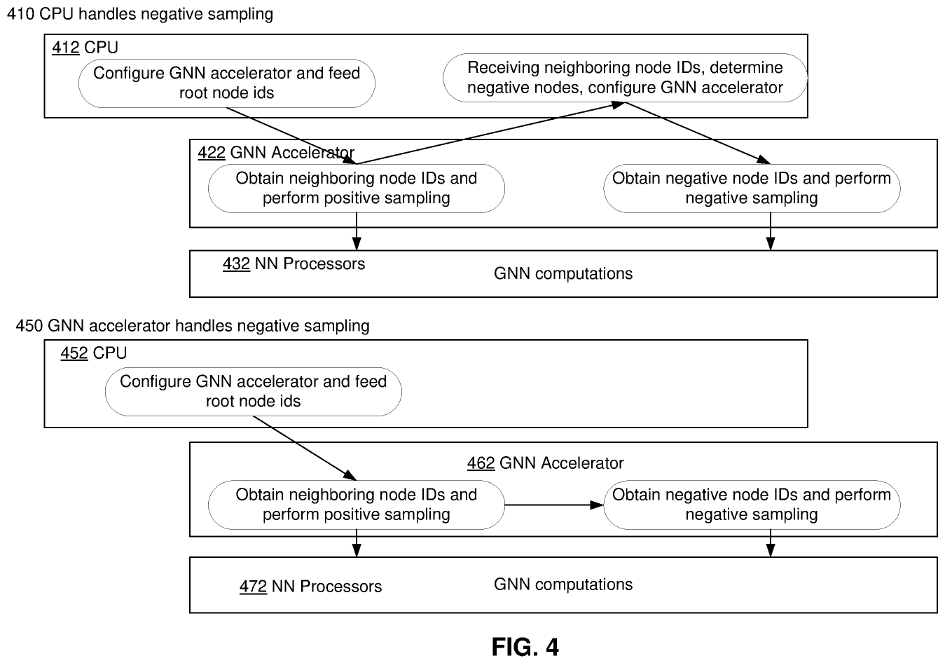

FIG. 4 illustrates technical advantages of an exemplary GNN accelerator architecture with built-in negative sampling in accordance with some embodiments. FIG. 4 shows a comparison between using a CPU to schedule negative sampling (diagram 410) and using a GNN accelerator with built-in negative sampling function (diagram 450).

In diagram 410, the CPU 412 may first configure the GNN accelerator 422 for positive sampling. For instance, the CPU 412 may send root node IDs to the GNN accelerator 422 and indicate this is for positive sampling. The GNN accelerator 422 may then obtain candidate nodes of the root nodes (e.g., adjacent nodes) from external memory or internal buffer and perform positive sampling on the candidate nodes. The GNN accelerator 422 may also fetch attribute data of the sampled nodes for the NN processors 432 to perform GNN computations.

The obtained candidate nodes of the root nodes may also be sent back to the CPU 412 so that the CPU 412 can schedule the negative sampling task. For example, the CPU 412 may select nodes other than the candidate nodes as the negative nodes, and send the negative nodes to the GNN accelerator 422 to perform sampling. The sampling here may refer to a positive sampling based on the negative nodes, which is equivalent to a negative sampling for the root nodes. The attribute data of the sampling results may be sent to the NN processor 432 to perform GNN computation.

During this process, the interaction between the CPU 412 and the GNN accelerator 422 includes two rounds of sampling instructions and data transfer of the candidate nodes. As shown in diagram 450, the interaction between the CPU 412 and the GNN accelerator 422 may be minimized to one sampling instruction by using a GNN accelerator 462 with a built-in negative sampling function.

In some embodiments, the CPU 452 may send a set of instructions to the GNN accelerator 462 to perform GNN sampling for one or more root nodes of a graph. The set of instructions may include root node IDs, a batch size, an indicator of sampling mode (e.g., positive sampling only, or positive and negative sampling), other suitable information, or any combination thereof.

Assuming the CPU 452 instructed the GNN accelerator 462 to perform both positive sampling and negative sampling for a root node, the GNN accelerator 462 may obtain the candidate nodes of the root node and send the candidate nodes to a positive sampler and a negative sampler. The positive sampler performs positive sampling on the candidate nodes to obtain positive nodes (e.g., nodes that with in k-th order neighborhood of the root node, also called first positive nodes), and the negative sampler performs negative sampling based on graph nodes other than the candidate nodes to obtain provisional negative nodes. For example, upon receiving the candidate nodes, the negative sampler may first identify some graph nodes that outside of the candidate nodes from the graph, and then determine the provisional negative nodes from those identified graph nodes. The attribute data of the positive nodes may be sent to the NN processors 472 for GNN computation as positive sampling results. The provisional negative nodes may be further processed in another round of positive sampling, which may include, for each provisional negative node, determining, by the GNN accelerator 462, one or more second positive nodes that are connected to the provisional negative node. The attribute data of the second positive nodes may be sent to the NN processors 472 for GNN computation as negative sampling results. The first positive nodes and the second positive nodes may be non-overlapping. In other words, the second positive nodes may not be within the k-th order neighborhood of the root node.

As shown, by using the GNN accelerator 462 with the built-in negative sampling function, the interactions between the CPU 452 and the GNN accelerator 462 may be minimized. The related scheduling delays are accordingly minimized. This way, the GNN sampling efficiency and the overall GNN processing performance is improved.

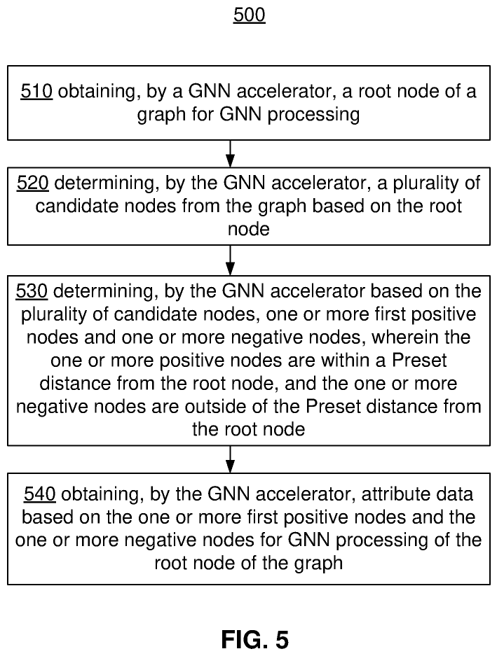

FIG. 5 illustrates an exemplary method of accelerating GNN processing with built-in negative sampling in accordance with some embodiments. The method 500 may be implemented in an environment shown in FIG. 1. The method 500 may be performed by a device, apparatus, or system illustrated by FIGS. 1-4, such as the accelerator 300 in FIG. 3, the accelerator 422 and 462 in FIG. 4. Depending on the implementation, the method 500 may include additional, fewer, or alternative steps performed in various orders or parallel.

Step 510 includes obtaining a root node of a graph for GNN processing. In some embodiments, the obtaining the root node of the graph comprises: receiving the root node from a CPU separated from the GNN accelerator. In some embodiments, the obtaining the root node of the graph comprises: receiving a batch size from a processor separated from the GNN accelerator; and obtaining from the graph the batch size of root nodes comprising the root node.

Step 520 includes determining a plurality of candidate nodes from the graph based on the root node. In some embodiments, the determining the plurality of candidate nodes from the graph based on the root node comprises: determining the plurality of candidate nodes that are within the k-th order neighborhood of the root node (k is a preset distance from the root node). In some embodiments, the determining the one or more first positive nodes based on the plurality of candidate nodes comprises: sampling a subset of the plurality of candidate nodes of the root node; and the determining the one or more negative nodes based on the plurality of candidate nodes comprises: determining one or more provisional negative nodes in the graph other than the plurality of candidate nodes of the root node; and sampling the one or more negative nodes from the one or more provisional negative nodes.

Step 530 includes determining, based on the plurality of candidate nodes, one or more first positive nodes and one or more negative nodes, wherein the one or more positive nodes are within a preset distance from the root node, and the one or more negative nodes are outside of the preset distance from the root node. In some embodiments, the determining the one or more negative nodes comprises: determining a plurality of provisional negative nodes in the graph other than the plurality of candidate nodes of the root node; and sampling a subset of the plurality of provisional negative nodes. In some embodiments, the determining the one or more negative nodes comprises: determining one or more provisional negative nodes in the graph other than the plurality of candidate nodes of the root node; storing the one or more provisional negative nodes in a negative sample node buffer of the GNN accelerator for another round of positive sampling; and for each of the one or more provisional negative nodes, determining, by the GNN accelerator, one or more second positive nodes that are within the preset distance from the provisional negative node

Step 540 includes obtaining attribute data based on the one or more first positive nodes and the one or more negative nodes for GNN processing of the root node of the graph. In some embodiments, the obtaining attribute data based on the one or more first positive nodes and the one or more negative nodes for GNN processing of the root node of the graph comprises: obtaining the attribute data of the one or more first positive nodes and the one or more second positive nodes for the GNN processing of the root node of the graph.

In some embodiments, the method 500 further comprises training a neural network to generate a feature representation of the root node based on the attribute data of the one or more first positive nodes as positive samples and the attribute data of the one or more second positive nodes as negative samples. In some embodiments, the training comprises: training the neural network to generate a feature representation of the root node, wherein the training comprises minimizing a feature distance (e.g., a vector distance such as Euclidean distance) from the feature representation of the root node to feature representations of the one or more first positive nodes, and maximizing a feature distance from the feature representation to feature representations of the one or more second positive nodes, wherein the feature representations of the one or more first positive nodes are determined based on the attribute data of the one or more first positive nodes, and the feature representations of the one or more second positive nodes are determined based on the attribute data of the one or more second positive nodes.

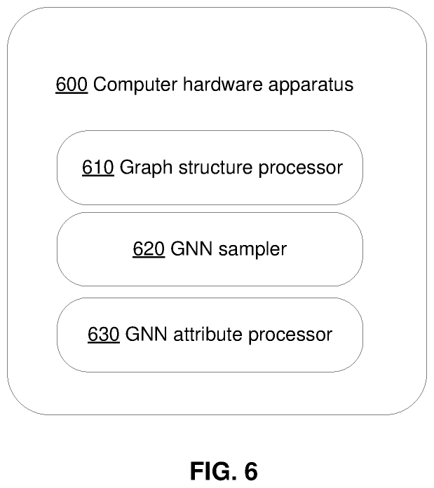

FIG. 6 illustrates a block diagram of a computer system apparatus for accelerating GNN processing with built-in negative sampling in accordance with some embodiments. The components of the computer system apparatus 600 presented below are intended to be illustrative. Depending on the implementation, the computer system apparatus 600 may include additional, fewer, or alternative components.

The computer system apparatus 600 may be an example of implementing the method 500 of FIG. 5. The computer system apparatus 600 may include one or more processors and one or more non-transitory computer-readable storage media (e.g., one or more memories) coupled to the one or more processors and configured with instructions executable by the one or more processors to cause the system or device (e.g., the processor) to perform the above-described embodiments. The computer system apparatus 600 may include various units/modules corresponding to the instructions (e.g., software instructions). The apparatus 600 may be implemented as the GNN accelerator 300 in FIG. 3.

In some embodiments, the computer hardware apparatus 600 may be referred to as an apparatus for accelerating GNN processing by improving sampling efficiency. The computer hardware apparatus 600 may include a graph structure processor 610, a GNN sampler 620, and a GNN attribute processor 630. These units may be implemented by the hardware devices and electronic circuits illustrated in FIGS. 1-5.

In some embodiments, the graph structure processor 610 may be configured to obtain, according to a root node in a graph, a plurality of candidate nodes for the root node from the graph. The GNN sampler 620 may be configured to generate sampled graph nodes based on the plurality of candidate nodes from the graph structure processor. The GNN attribute processor 630 may be configured to fetch attribute data of the sampled graph nodes received from the GNN sampler for GNN processing, such as training GNN parameters based on features of the root node and the sampled graph nodes, or computing a feature representation (e.g., a vector) of the root node based on the features of the sampled graph nodes.

In some embodiments, the GNN sampler 620 comprises: a positive sampler configured to sample one or more first positive nodes from the plurality of candidate nodes; and a negative sampler configured to determine a plurality of nodes in the graph other than the plurality of candidate nodes and sample one or more negative nodes from the plurality of determined nodes. The GNN sampler 620 may be further configured to send the one or more first positive nodes to the GNN attribute processor for fetching corresponding attribute data; and send the one or more negative nodes to the graph structure processor for another round of sampling. In some embodiments, the GNN attribute processor 630 is further configured to: fetch attribute data of the one or more first positive nodes for training a neural network to generate a feature representation of the root node and minimize a feature distance from the feature representation to the attribute data of the one or more first positive nodes.

In some embodiments, the graph structure processor 610 is further configured to: store one or more provisional negative nodes received from the GNN sampler in a buffer; and for each of the one or more provisional negative nodes, obtain a plurality of candidate nodes of the provisional negative node that are connected to and within a distance from the provisional negative node. The GNN sampler 620 is further configured to: sample one or more second positive nodes from the plurality of candidate nodes for the provisional negative node. The GNN attribute processor 630 is further configured to: fetch attribute data of the one or more second positive nodes for training a neural network to generate a feature representation of the root node and maximize a feature distance from the feature representation to the attribute data of the one or more second positive nodes.

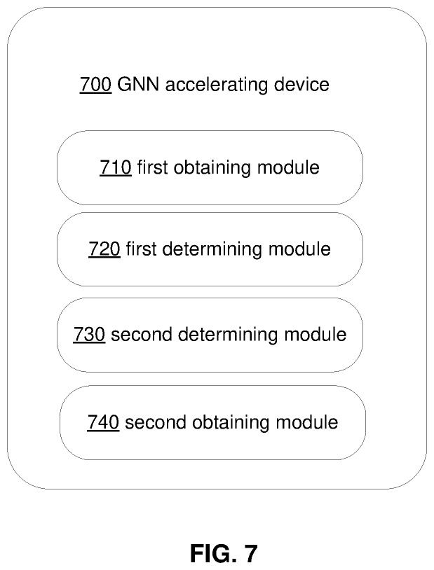

FIG. 7 illustrates a block diagram of a GNN accelerating device 700 with built-in negative sampling in accordance with some embodiments. The components of the GNN accelerating device 700 presented below are intended to be illustrative. Depending on the implementation, the GNN accelerating device 700 may include additional, fewer, or alternative components.

In some embodiments, the GNN accelerating device 700 may include a first obtaining module 710, a first determining module 720, a second determining module 730, and a second obtaining module 740.

In some embodiments, the first obtaining module 710 may be configured to obtain a root node of a graph for GNN processing. The GNN processing may generally refer to computing a feature representation (e.g., a vector) of the root node for training a GNN or inference using the trained GNN. In some embodiments, the first determining module 720 may be configured to determine a plurality of candidate nodes from the graph based on the root node. In some embodiments, the second determining module 730 may be configured to determine, based on the plurality of candidate nodes, one or more first positive nodes and one or more negative nodes, wherein the one or more first positive nodes are within a distance from the root node, and the one or more negative nodes are outside of the distance from the root node.

In some embodiments, the second obtaining module 740 may be configured to obtain attribute data based on the one or more first positive nodes and the one or more negative nodes for GNN processing on the root node of the graph. In some embodiments, the second obtaining module 740 may be further configured to obtain attribute data of the one or more first positive nodes and attribute data of the one or more second positive nodes for training a neural network to generate a feature representation of the root node. The training may include minimizing a feature distance from the feature representation to the attribute data of the one or more first positive nodes and maximizing a feature distance from the feature representation to the attribute data of the one or more second positive nodes.

In some embodiments, the second obtaining module 740 of the GNN accelerating device 700 may be further configured to determine one or more provisional negative nodes in the graph other than the plurality of candidate nodes of the root node; and for each of the one or more provisional negative nodes, determine one or more second positive nodes that are within the preset distance from the provisional negative node using positive sampling.

Each process, method, and algorithm described in the preceding sections may be embodied in, and fully or partially automated by, code modules executed by one or more computer systems or computer processors comprising computer hardware. The processes and algorithms may be implemented partially or wholly in application-specific circuit.

When the functions disclosed herein are implemented in the form of software functional units and sold or used as independent products, they can be stored in a processor executable non-volatile computer-readable storage medium. Particular technical solutions disclosed herein (in whole or in part) or aspects that contribute to current technologies may be embodied in the form of a software product. The software product may be stored in a storage medium, comprising a number of instructions to cause a computing device (which may be a personal computer, a server, a network device, and the like) to execute all or some steps of the methods of the embodiments of the present application. The storage medium may comprise a flash drive, a portable hard drive, ROM, RAM, a magnetic disk, an optical disc, another medium operable to store program code, or any combination thereof.

Particular embodiments further provide a system comprising a processor and a non-transitory computer-readable storage medium storing instructions executable by the processor to cause the system to perform operations corresponding to steps in any method of the embodiments disclosed above. Particular embodiments further provide a non-transitory computer-readable storage medium configured with instructions executable by one or more processors to cause the one or more processors to perform operations corresponding to steps in any method of the embodiments disclosed above.

Embodiments disclosed herein may be implemented through a cloud platform, a server or a server group (hereinafter collectively the “service system”) that interacts with a client. The client may be a terminal device, or a client registered by a user at a platform, where the terminal device may be a mobile terminal, a personal computer (PC), and any device that may be installed with a platform application program.

The various features and processes described above may be used independently of one another or may be combined in various ways. All possible combinations and sub-combinations are intended to fall within the scope of this disclosure. In addition, certain methods or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel, or in some other manner. Blocks or states may be added to or removed from the disclosed example embodiments. The exemplary systems and components described herein may be configured differently than described. For example, elements may be added to, removed from, or rearranged compared to the disclosed example embodiments.

The various operations of example methods described herein may be performed, at least partially, by an algorithm. The algorithm may be comprised in program codes or instructions stored in a memory (e.g., a non-transitory computer-readable storage medium described above). Such algorithm may comprise a machine learning algorithm. In some embodiments, a machine learning algorithm may not explicitly program computers to perform a function but can learn from training data to make a prediction model that performs the function.

The various operations of example methods described herein may be performed, at least partially, by one or more processors that are temporarily configured (e.g., by software) or permanently configured to perform the relevant operations. Whether temporarily or permanently configured, such processors may constitute processor-implemented engines that operate to perform one or more operations or functions described herein.

Similarly, the methods described herein may be at least partially processor-implemented, with a particular processor or processors being an example of hardware. For example, at least some of the operations of a method may be performed by one or more processors or processor-implemented engines. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an Application Program Interface (API)).

The performance of certain of the operations may be distributed among the processors, not only residing within a single machine, but deployed across a number of machines. In some example embodiments, the processors or processor-implemented engines may be located in a single geographic location (e.g., within a home environment, an office environment, or a server farm). In other example embodiments, the processors or processor-implemented engines may be distributed across a number of geographic locations.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the subject matter has been described with reference to specific example embodiments, various modifications and changes may be made to these embodiments without departing from the broader scope of embodiments of the present disclosure. Such embodiments of the subject matter may be referred to herein, individually or collectively, by the term “invention” merely for convenience and without intending to voluntarily limit the scope of this application to any single disclosure or concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

Any process descriptions, elements, or blocks in the flow diagrams described herein and/or depicted in the attached figures should be understood as potentially representing modules, segments, or sections of code which include one or more executable instructions for implementing specific logical functions or steps in the process. Alternate implementations are included within the scope of the embodiments described herein in which elements or functions may be deleted, executed out of order from that shown or discussed, including substantially concurrently or in reverse order, depending on the functionality involved, as would be understood by those skilled in the art.

As used herein, “or” is inclusive and not exclusive, unless expressly indicated otherwise or indicated otherwise by context. Therefore, herein, “A, B, or C” means “A, B, A and B, A and C, B and C, or A, B, and C,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context. Moreover, plural instances may be provided for resources, operations, or structures described herein as a single instance. Additionally, boundaries between various resources, operations, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

The term “include” or “comprise” is used to indicate the existence of the subsequently declared features, but it does not exclude the addition of other features. Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

What is claimed is:

1. A computer-implemented method for accelerating Graph Neural Network (GNN), comprising:
obtaining, by a GNN accelerator, a root node of a graph for GNN processing;
determining, by the GNN accelerator, a plurality of candidate nodes from the graph based on the root node;
determining, by the GNN accelerator based on the plurality of candidate nodes, one or more first positive nodes and one or more negative nodes, wherein the one or more first positive nodes are within a preset distance from the root node, and the one or more negative nodes are outside of the preset distance from the root node; and
obtaining, by the GNN accelerator, attribute data based on the one or more first positive nodes and the one or more negative nodes for GNN processing on the root node of the graph.

2. The method of claim 1, wherein the plurality of candidate nodes are within k-th order neighborhood of the root node, wherein k is a preset distance from the root node.

3. The method of claim 2, wherein the determining the one or more first positive nodes based on the plurality of candidate nodes comprises:
sampling a subset of the plurality of candidate nodes of the root node; and
the determining the one or more negative nodes based on the plurality of candidate nodes comprises:
determining one or more provisional negative nodes in the graph other than the plurality of candidate nodes of the root node; and
sampling the one or more negative nodes from the one or more provisional negative nodes.

4. The method of claim 1, wherein the determining the one or more negative nodes comprises:
determining one or more provisional negative nodes in the graph other than the plurality of candidate nodes of the root node; and
storing the one or more provisional negative nodes in a negative sample node buffer of the GNN accelerator for another round of positive sampling.

5. The method of claim 4, wherein the determining the one or more negative nodes further comprises:
for each of the one or more provisional negative nodes, determining, by the GNN accelerator, one or more second positive nodes that are within the preset distance from the provisional negative node.

6. The method of claim 5, wherein the obtaining attribute data based on the one or more negative nodes for GNN processing on the root node of the graph comprises:
obtaining the attribute data of the one or more second positive nodes for the GNN processing on the root node of the graph.

7. The method of claim 5, wherein the obtaining attribute data based on the one or more negative nodes for GNN processing on the root node of the graph comprises:
obtaining the attribute data of the one or more second positive nodes and the plurality of provisional negative nodes for the GNN processing on the root node of the graph.

8. The method of claim 5, the GNN processing on the root node comprising:
training a neural network to generate a feature representation of the root node, wherein the training comprises minimizing a feature distance from the feature representation of the root node to feature representations of the one or more first positive nodes, wherein the feature representations of the one or more first positive nodes are determined based on the attribute data of the one or more first positive nodes.

9. The method of claim 5, the GNN processing on the root node further comprising:
training a neural network to generate a feature representation of the root node, wherein the training comprises maximizing a feature distance from the feature representation to feature representations of the one or more second positive nodes, wherein the feature representations of the one or more second positive nodes are determined based on the attribute data of the one or more second positive nodes.

10. The method of claim 1, wherein the obtaining the root node of the graph comprises:
receiving a batch size from a processor separated from the GNN accelerator; and
obtaining from the graph the batch size of root nodes comprising the root node.

11. A Graph Neural Network (GNN) accelerator comprising:
a graph structure processor configured to obtain, according to a root node in a graph, a plurality of candidate nodes for GNN processing on the root node;
a GNN sampler configured to generate sampled graph nodes based on the plurality of candidate nodes from the graph structure processor; and
a GNN attribute processor configured to fetch attribute data of the sampled graph nodes received from the GNN sampler for the GNN processing on the root node.

12. The GNN accelerator of claim 11, wherein the plurality of candidate nodes are within k-th order neighborhood of the root node, wherein k is a preset distance from the root node.

13. The GNN accelerator of claim 11, wherein the GNN sampler comprises:
a positive sampler configured to sample one or more first positive nodes from the plurality of candidate nodes and send the one or more first positive nodes to the GNN attribute processor for fetching corresponding attribute data; and
a negative sampler configured to sample one or more provisional negative nodes from a plurality of nodes in the graph other than the plurality of candidate nodes and send the one or more provisional negative nodes back to the graph structure processor for another round of positive sampling based on the one or more provisional negative nodes.

14. The GNN accelerator of claim 13, wherein the GNN attribute processor is further configured to:
fetch attribute data of the one or more first positive nodes for training a neural network to generate a feature representation of the root node, wherein the training comprises minimizing a feature distance from the feature representation of the root node to feature representations of the one or more first positive nodes, wherein the feature representations of the one or more first positive nodes are determined based on the attribute data of the one or more first positive nodes.

15. The GNN accelerator of claim 13, wherein the graph structure processor is further configured to:
for each of the one or more provisional negative nodes, obtain a plurality of candidate nodes of the provisional negative node that are within the first to k-th order neighborhood of the provisional negative node, wherein k is a preset distance from the provisional negative node.

16. The GNN accelerator of claim 15, wherein the GNN sampler is further configured to:
sample one or more second positive nodes from the plurality of candidate nodes of the provisional negative node.

17. The GNN accelerator of claim 16, wherein the GNN attribute processor is further configured to:
fetch attribute data of the one or more second positive nodes for training a neural network to generate a feature representation of the root node, wherein the training comprises maximizing a feature distance from the feature representation to feature representations of the one or more second positive nodes, wherein the feature representations of the one or more second positive nodes are determined based on the attribute data of the one or more second positive nodes.

18. A Graph Neural Network (GNN) accelerating device, comprising:
a first obtaining module configured to obtain a root node of a graph for GNN processing;
a first determining module configured to determine a plurality of candidate nodes from the graph based on the root node;
a second determining module configured to determine, based on the plurality of candidate nodes, one or more first positive nodes and one or more negative nodes, wherein the one or more first positive nodes are within a preset distance from the root node, and the one or more negative nodes are outside of the preset distance from the root node; and
a second obtaining module configured to obtain attribute data based on the one or more first positive nodes and the one or more negative nodes for GNN processing on the root node of the graph.

19. The GNN accelerating device of claim 18, wherein the second obtaining module is further configured to:
determine one or more provisional negative nodes in the graph other than the plurality of candidate nodes of the root node; and
for each of the one or more provisional negative nodes, determine one or more second positive nodes that are within the preset distance from the provisional negative node using positive sampling.

20. The GNN accelerating device of claim 19, wherein the second obtaining module is further configured to:
obtain attribute data of the one or more first positive nodes and attribute data of the one or more second positive nodes for training a neural network to generate a feature representation of the root node to:
minimize a feature distance from the feature representation of the root node to feature representations of the one or more first positive nodes, wherein the feature representations of the one or more first positive nodes are generated based on the attribute data of the one or more first positive nodes, and
maximize a feature distance from the feature representation of the root node to feature representations of the one or more second positive nodes, wherein the feature representations of the one or more second positive nodes are generated based on the attribute data of the one or more second positive nodes.
